(19) United States
(12) Patent Application Publication
(10) Pub. No.: US 2006/0206539 A1
(43) Pub. Date: Sep. 14, 2006

(54) Method and system for retroactive logging

(75) Inventor: Kevin W. Thompson, Sunnyvale, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: Macrovision Corporation

(21) Appl. No.: 11/076,362

(22) Filed: Mar. 9, 2005

(51) Int. Cl. G06F 17/30

(52) U.S. Cl. 707/202

(57) ABSTRACT

A method and system for retroactive logging disclosed. In one embodiment, the method comprises commencing the execution of an operation of a software application. When beginning a critical operation capable of generating enormous amounts of log data, the application opens a buffer to store log information that describes the operation in detail. The buffer is flushed upon successful completion of the operation, but retained if the operation failed. The final contents of the buffer are then written to a log file at the appropriate logging level. The result is that the log file contains copious data about the failure of an operation, but little data in the event that an operation is successful. Thus the application log provides the necessary details to diagnose failures, while avoiding the recording of large quantities of unnecessary information when the operations succeed.

### FIELD OF THE INVENTION

The field of the invention relates generally to computer systems and more particularly relates to a method and system for retroactive logging.

### BACKGROUND OF THE INVENTION

Most software applications include a mechanism for tracking the operation of the software application by recording important events and error conditions in a file, which is often referred to as an application log. For example, the process of connecting to an email server, and transferring email messages, can be complex, and errors can occur in many different ways. Finding out why something failed, and what needs to be done to fix the failure, can be a frustrating and time-consuming process. This is especially true when connection problems occur far from the person responsible for diagnosing and fixing them. Thus it is important that the information required to diagnose and correct the problem be found in the application log.

A typical technical-support scenarios works as follows. A user encounters an error message or failure while using the software application, one that can not be easily remedied. The user calls technical support and describes the problem to the tech support agent. The tech support agent may request that the user e-mail an application log for the software application that contains information regarding the operation of the software application. Yet often the tech support agent will be frustrated at finding that there is very little information in the log file relevant to the problem, or that there is so much information in the log file, that it is impossible to find the event that caused the error to occur.

For these reasons, in this example, it is desirable on the one hand to have a comprehensive log of all application events for review when trying to solve a problem. On the other hand, the amount of information that a comprehensive log can contain may be enormous, especially as the log for an email-based apploication may contain the full text of all transferred messages.

Present application-log generation mechanisms do not adequately address these conflicting requirements. Particularly, present logging mechanisms do not properly determine how much operation information should be recorded, and when the information should be written to the log file. These problems make it very difficult for human beings to diagnose problems efficiently.

### SUMMARY

A method and system for retroactive logging are disclosed. In one embodiment, the method comprises commencing the execution of an operation of a software application. When beginning a critical operation capable of generating enormous amounts of log data, the application opens a buffer to store log information that describes the operation in detail. The buffer is flushed upon successful completion of the operation, but retained if the operation failed. The final contents of the buffer are then written to a log file at the appropriate logging level. The result is that the log file contains copious data about the failure of an operation, but little data in the event that an operation is successful. Thus the application log provides the necessary details to diagnose failures, while avoiding the recording of large quantities of unnecessary information when the operations succeed.

The above and other preferred features, including various novel details of implementation and combination of elements, will now be more particularly described with reference to the accompanying drawings and pointed out in the claims. It will be understood that the particular methods and circuits described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment of the present invention and together with the general description given above and the detailed description of the preferred embodiment given below serve to explain and teach the principles of the present invention.

FIG. 1 illustrates a block diagram of an exemplary software license management systems, according to one embodiment of the present invention;

FIG. 2 illustrates an exemplary computer architecture for use with the present system, according to one embodiment of the invention;

FIG. 3 illustrates a block diagram of exemplary software modules and files residing on the front-end server, according to one embodiment of the present invention; and

FIG. 4 illustrates a flow diagram of an exemplary retroactive logging process, according to one embodiment of the present invention.

### DETAILED DESCRIPTION

A method and system for retroactive logging are disclosed. In one embodiment, the method comprises commencing the execution of an operation of a software application. When beginning a critical operation capable of generating enormous amounts of log data, the application opens a buffer to store log information that describes the operation in detail. The buffer is flushed upon successful completion of the operation, but retained if the operation failed. The final contents of the buffer are then written to a log file at the appropriate logging level. The result is that the log file contains copious data about the failure of an operation, but little data in the event that an operation is successful. Thus the application log provides the necessary details to diagnose failures, while avoiding the recording of large quantities of unnecessary information when the operations succeed.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

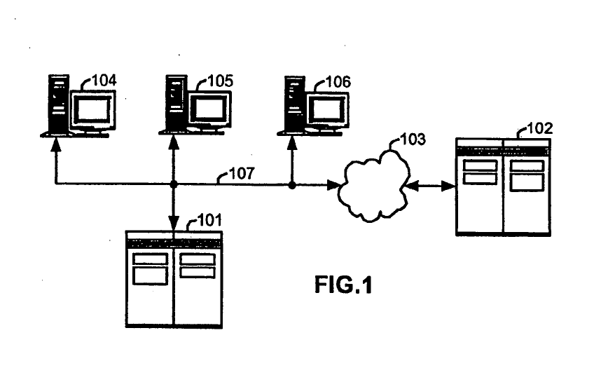

FIG. 1 illustrates a block diagram of an exemplary software license management systems, according to one embodiment of the present invention. In addition to license management systems, it is to be appreciated that other systems employing the various teachings herein may also be used to practice the various aspects of the present invention, and as such, are considered to be within its full scope. Additional systems include e-mail programs (e.g., Outlook, Notes, Yahoo! Mail, gmail, etc.), and any other software application that generates application logs that trace and record its operation.

System 100 includes a front-end server 101 that is configurable to control usage of licensed software, receives e-mail messages, and securely transmits the e-mail messages to a back-end server 102 corresponding to a designated destination, such as a direct dial-up telephone number, an Internet Uniform Resource Locator (URL), an email address or other networking address. Front-end server can be a mail server for a company, as well. The licensed software application is operative on various front-end computers connected in a network 107, including the front-end server 101 and other computers represented as computers 104-106. The network 107 may be a Local Area Network (LAN), Wide Area Network (WAN), Virtual Private Network (VPN), or other network that is managed or otherwise controlled by a customer of the licensed software. Communication between the front-end server 101, which preferably resides at a location designated or authorized by the customer of the licensed software, and the back-end server 102, which preferably resides at a location designated or authorized by a vendor of the licensed software, is performed through a communication medium 103, such as the Internet, a private network or a direct dial-up connection. In the case of the Internet, secure transmission of an e-mail is preferably performed, for example, using the Secure Sockets Layer protocol (SSL), a Virtual Private Network (VPN), and/or encrypted email attachments.

Alternatively, any one or more of the front-end computers represented by front-end computers 104-106 on the network 107 may be configured, instead of or in addition to the front-end server 101, to control usage of its licensed software and/or the licensed software of other such computers, generate e-mail messages, and securely transmit the e-mail messages to the back-end server 102. Accordingly, as used herein and in the following claims, the term “front-end server” is understood to also include such front-end computers when performing such functions. In addition to certain of the front-end computers being configured to run the licensed application software, the front-end server 101 may also be so configured.

The back-end server 102 is configured to receive, authenticate, and process the e-mail messages, and deliver the e-mail messages to the end recipient that could be an individual or software entity, such as business operations software. Examples of such business operations software include enterprise resource planning software (ERP), e-commerce software (such as those used for performing transactions over the Internet), customer relationship management software (CRM), and sales force automation software (SFA).

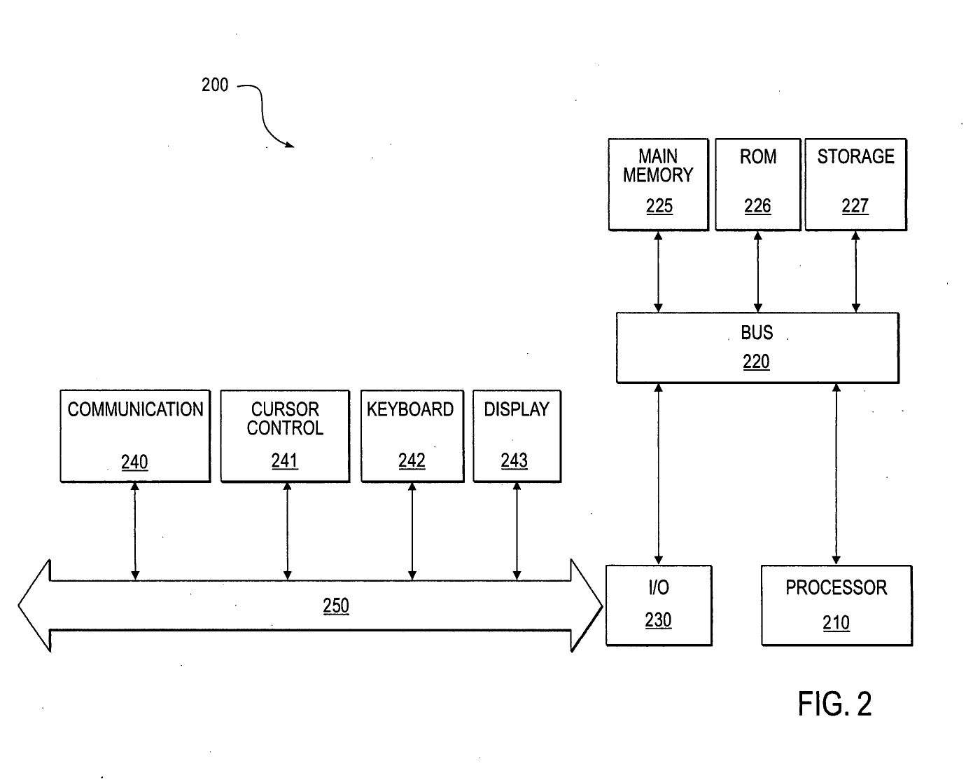

FIG. 2 illustrates an exemplary computer architecture for use with the present system, according to one embodiment of the invention. Computer architecture 200 can be used to implement both front-end computers 104-106, front-end servers 101, and back-end servers 102 of FIG. 1. One embodiment of architecture 200 comprises a system bus 220 for communicating information, and a processor 210 coupled to bus 220 for processing information. Architecture 200 further comprises a random access memory (RAM) or other dynamic storage device 225 (referred to herein as main memory), coupled to bus 220 for storing information and instructions to be executed by processor 210. Main memory 225 also may be used for storing temporary variables or other intermediate information during execution of instructions by processor 210. Architecture 200 also may include a read only memory (ROM) and/or other static storage device 226 coupled to bus 220 for storing static information and instructions used by processor 210.

A data storage device 227 such as a magnetic disk or optical disc and its corresponding drive may also be coupled to computer system 200 for storing information and instructions. Architecture 200 can also be coupled to a second I/O bus 250 via an I/O interface 230. A plurality of I/O devices may be coupled to I/O bus 250, including a display device 243, an input device (e.g., an alphanumeric input device 242 and/or a cursor control device 241). For example, web pages and business related information may be presented to the user on the display device 243.

The communication device 240 allows for access to other computers (servers or clients) via a network. The communication device 240 may comprise a modem, a network interface card, a wireless network interface or other well known interface device, such as those used for coupling to Ethernet, token ring, or other types of networks.

Having described the hardware involved in a computer network such as system 100, the present method for retroactive logging will be described. Returning to the example of an e-mail application that generates an application log, ideally, the desired approach to logging connection information is to record minimal status information when an operation of the application succeeds (e.g., an e-mail message is successfully sent from a front-end computer 104-106 to the front-end server 101), and comprehensive information when it fails. Since the decision about what to record has to be made after the fact, the present method and system provide retroactive logging.

Retroactive logging uses a recorder object that records all interactions at the finest level while the client tries to connect to the server. If the connection is successful, the record is erased, and a brief status message is recorded. If the connection fails, the full record is retained. In either case, the contents of the record are written to the log file afterwards. The recorder object allows for the logging of a proper amount of detail for the application's operations (e.g., connections with the front-end server 101).

In an e-mail system it is during connection where errors are most likely to occur. Occasionally, however, errors may arise during a session after the connection has succeeded; for example, the transmission of an email message may be aborted due to a problem such as limits on allowed message sizes. For these situations, it is desirable to allow for the logging of the session activities after the connection has been established. Thus, the option to log all email activity at the most comprehensive level must also be provided.

According to one embodiment, when used with a license manager such as FLEXlm manufactured by Macrovision Corporation of Santa Clara, Calif., includes agent and receiver configuration files (agent.xml and receiver.xml) that contain information used to establish connections to email servers, such as front-end server 101. They will also contain elements that define the desired logging activity, i.e. to log none of the post-connection session interactions, or to log all of the session interactions.

Receiver Configuration File

According to one embodiment, a receiver of a distributed license manager gets its configuration information from an XML file (e.g., receiver.xml). The receiver is part of back-end server 102 and includes a receiver configuration file, one example of this file is illustrated below:

<mailHost>smtp.company.com</mailHost>
<mailFrom>receiver@vendor.com</mailFrom>
<mailAccount>username</mailAccount>
<mailPassword>password</mailPassword>
<mailLogging level=“brief|verbose”/>
<inboundMailHost>imap.company.com</inboundMailHost>
<inboundMailAccount>username</inboundMailAccount>
<inboundMailPassword>password</inboundMailPassword>
<inboundMailLogging level=“brief|verbose”/>

The <mailLogging> and <inboundMailLogging> elements control the amount of information recorded, and logged, about the client's efforts to connect to and exchange messages with the outbound and inbound email servers. Setting level to “verbose” records every detail, while setting it to “brief” records only acknowledgement of successful connections, and every detail of failed connections. If the element is omitted, the default behavior is the same as the “brief” level.)

Agent Configuration File

An agent resident in the front-end server 101 gets its configuration information from an XML file (e.g., agent.xml). The agent uses configuration information to implement the retroactive-logging capability for recording email sessions. Thus, an element is added to the agent (e.g., agent.xml) file:

<mailLogging level=“brief|verbose”/>

The <mailLogging> element controls the amount of information recorded, and logged, about the client's efforts to connect to and exchange messages with the inbound email server. Setting level to “verbose” records every detail, while setting it to “none” records only acknowledgement of successful connections, and every detail of failed connections. If the element is omitted, the default behavior is the same as the “brief” level.

Severity Levels

The present retroactive logging method and system allows for a spectrum of logging levels, each having a certain granularity. For example, at one level, errors are recorded on a log—this may be referred to as the error level (or “none” parameter as described above). This level may also include an indication of when operations complete. Errors occur relatively infrequently and it would be expected that a log that records only errors would not be very useful for debug purposes. If warnings and errors are recorded, this level may be referred to as the warning level. If general operational information, warnings and errors are recorded in the log, this level may be referred to as the information level (or “brief” as described above). If debug information, operational information, warnings, and errors are reported in a log, then this level may be referred to as a debug level (or “verbose” as described above). At the debug level, every piece of information is written to the log file.

The present method and system allow a minimal amount of entries to be logged (error level logging) when no errors are generated. However, in the event of an error, additional information may be recorded in the log at a warning, information, and/or debug level, automatically. This allows a human to focus on the event entered into the log that resulted in the error, without sifting through enormous amounts of information that is not related to the error.

The present method and system begins storing detailed logging information in buffers once an operation begins. The detailed logging information may be stored in memory, such as memory 225, 226. Once the operation completes successfully (e.g., without generating an errors), the buffer is purged. However, if an error is generated, then the buffered logging information is recorded in the log. A system designer/programmer can define what constitutes the successful completion of an operation by defining logic rules that identify an event as a logging trigger.

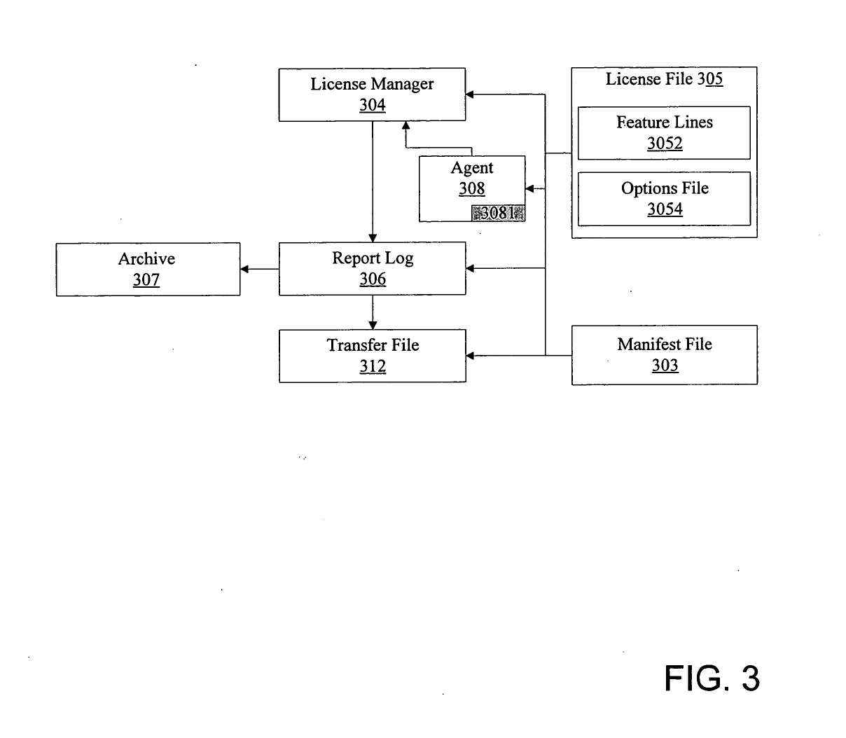

FIG. 3 illustrates a block diagram of exemplary software modules and files residing on the front-end server 101 that serve to configure the front-end server 101 for retroactive logging, according to one embodiment of the present invention. As stated above, a license manager architecture is only provided for illustrative purposes, the reader should understand that other systems that utilize application logging can benefit from the present method and system. Although information is shown as being stored in files in this example, it is to be appreciated that the information could also be stored in a registry, such as the Microsoft Windows Registry or even a network-wide system directory such as LDAP, or other similar systems used to store data. A license file 305 includes feature lines 3052 which describe the license terms for licensed software. Alternatively, instead of lines in a license file, such data may be stored as tagged data describing their respective license terms in a different file format, or as data within a database scheme or registry. A license manager 304 controls usage of the licensed software according to the license terms 3052, and generates, as appropriate, a report log 306 of such usage.

Each of the schedule-file lines in 304 provides information for transfer files 312 and each of the feature lines 3052 provides licensing information for one or more of the features of the licensed software. Generally, there are multiple features in a licensed software product, and sometimes, one feature may spread across multiple licensed software products. Separation of report schedule and feature lines allows multiple feature lines to be indexed to the same report schedule line so that, for example, different vendor business units individually identified in different feature lines can receive identically formatted reports of feature usage involving their products. Alternatively, usages of the same features may be reported in different or unique ways for the different business units.

An agent, service or daemon (hereinafter simply referred to as an “agent”) 308 running as a background process on the front-end server 101 serves as a scheduler to notify the license manager 304 that it is time to execute a report generator 310 to generate a transfer file 312 from information within the report log 306. Agent 308 includes an agent configuration file 3081 (as described above) that permits retroactive logging, according to one embodiment of the present invention. Although the agent 308 may be a separate module as shown in FIG. 3, preferably it is a part of the license manager 304 that is always running.

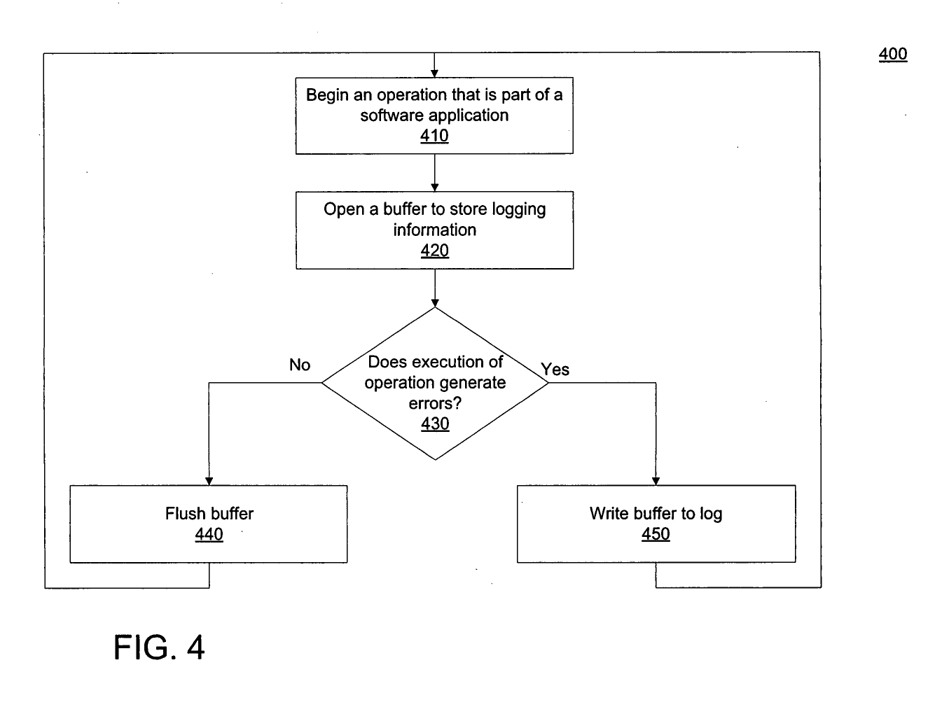

FIG. 4 illustrates a flow diagram of an exemplary retroactive logging process 400, according to one embodiment of the present invention. The retroactive logging process 400 is used with software applications that generate an application log during operation. The process 400 begins when execution of an operation is commenced, where an operation is one of many processes that make up a software application. (410) A buffer is opened and stores log information at a particular logging level. (420) The process 400 continues based on whether the operation completes successfully (e.g., the execution of the operation does not generate any errors). (430) If the operation completes successfully, then the buffer is flushed. (440) If the buffer is flushed, a simple entry is made in a log indicating that the operation executed successfully without errors. However, if errors are generated during the execution of the operation, then contents of the buffer are written to the log file. (450)

Although the present method and system have been described with respect to an e-mail service of a license management system, one of ordinary skill would understand that the techniques described may be used in any situation where an application log is generated by a software application.

A method and system for retroactive logging have been disclosed. Although the present method and system have been described with respect to specific examples and subsystems, it will be apparent to those of ordinary skill in the art that it is not limited to these specific examples or subsystems but extends to other embodiments as well.

I claim:

1. A computer-implemented method, comprising:
commencing the execution of an operation of a software application;
opening a buffer, the buffer storing log information according to a particular logging level;
flushing the buffer upon successful completion of the operation; and
writing contents of the buffer to a log file when execution of the operation results in one or more errors.

2. The computer-implemented method of claim 1, wherein the logging level is one of a plurality of logging levels including, error, warning, information, and debug.

3. The computer-implemented method of claim 2, wherein flushing the buffer comprises writing an entry into the log file that indicates that execution of the operation did not generate the one or more errors.

4. The computer-implemented method of claim 1, further comprising providing the log file from a front-end server to a back-end server automatically via e-mail.

5. The computer implemented method of claim 4, wherein the log file is used with a license management system.

6. The computer implemented method of claim 4, further comprising debugging the one or more errors at the back-end server.

7. A computer-readable medium having stored thereon a plurality of instructions, said plurality of instructions when executed by a computer, cause said computer to perform:
commencing the execution of an operation of a software application;
opening a buffer, the buffer storing log information according to a particular logging level;
flushing the buffer upon successful completion of the operation; and
writing contents of the buffer to a log file when execution of the operation results in one or more errors.

8. The computer-readable medium of claim 7, wherein the logging level is one of a plurality of logging levels including, error, warning, information, and debug.

9. The computer-readable medium of claim 8, wherein flushing the buffer comprises writing an entry into the log file that indicates that execution of the operation did not generate the one or more errors.

10. The computer-readable medium of claim 7, further comprising providing the log file from a front-end server to a back-end server automatically via e-mail.

11. The computer-readable medium of claim 10, wherein the log file is used with a license management system.

12. The computer-readable medium of claim 10, further comprising debugging the one or more errors at the back-end server.

13. A computer system, comprising:
a processor;
a buffer; and
memory coupled to the processor, the memory storing instructions;
wherein the instructions when executed by the processor cause the processor to, commence the execution of an operation of a software application;
open the buffer, the buffer storing log information according to a particular logging level;
flush the buffer upon successful completion of the operation; and
write contents of the buffer to a log file when execution of the operation results in one or more errors.

14. The computer system of claim 13, wherein the logging level is one of a plurality of logging levels including, error, warning, information, and debug.

15. The computer system of claim 14, wherein the processor writes an entry into the log file that indicates that execution of the operation did not generate the one or more errors, when the buffer is flushed.

16. The computer system of claim 13, further comprising a network connecting a front-end server to a back-end server, the log file being transferred on the network.

17. The computer system of claim 16, wherein the front-end server and the back-end server are part of a license management system.

18. The computer system of claim 17, wherein the one or more errors are debugged at the back-end server.
